(19) United States
(12) Patent Application Publication
(10) Pub. No.: US 2003/0196433 A1
(43) Pub. Date: Oct. 23, 2003

(54) Method for controlling a hydraulic activation unit

(75) Inventors: Martin Baer, Monheim (DE); Klaus Graner, Langenfeld (DE)

Correspondence Address: COHEN, PONTANI, LIEBERMAN & PAVANE, 551 FIFTH AVENUE, SUITE 1210, NEW YORK, NY, 10176, US

(73) Assignee: Komatsu Mining Germany GmbH

(21) Appl. No.: 10/395,691

(22) Filed: Mar. 24, 2003

(30) Foreign Application Priority Data
Mar. 22, 2002 (DE) 102 14 225.4

(51) Int. Cl. F16D 31/02

(52) U.S. Cl. 60/419

(57) ABSTRACT

A method of controlling an hydraulic activation unit includes the steps of using a characteristic diagram of a first hydraulic transformer as an input variable in the control unit; using a characteristic diagram of a second hydraulic transformer as an input variable in the control unit; and activating the hydraulic actuator responsive to the input variables. The hydraulic activation unit includes the hydraulic power unit, such as a hydraulic actuator or a hydraulic motor, for producing a force. The first hydraulic transformer is operably connected to a first side of the actuator for supplying a pressure. The second hydraulic transformer is operably connected to a second side of the actuator for supplying a pressure. The control unit for assessing the first and second hydraulic transformer operably activates the hydraulic actuator.

### 1. PRIORITY CLAIM

This application claims priority to application DE 102 14 225.4 filed on Mar. 22, 2002 in Germany.

### 2. FIELD OF THE INVENTION

The invention relates to a method for controlling a hydraulic activation unit. In particular the invention relates to controlling the use of two hydraulic transformers per hydraulic cylinder, as used in construction machinery.

### 3. BACKGROUND OF THE INVENTION

A controller for hydraulic transformers was proposed at the “Sixth Scandinavian International Conference of Fluid Power” (1999, Tampere, Finland) by P. Achten and Dr. J. O. Palmberg. Instead of the customary controller with control valves, a hydraulic transformer was proposed.

Furthermore, S. Rotthäuser and P. Achten have disclosed in the periodical “O+P” No. 42, (1998) a circuit with a hydraulic transformer at each of the two terminals of a hydraulic cylinder. However, no further details were given on the necessary controller or regulator.

The controller proposed at the “Sixth Scandinavian International Conference of Fluid Power” has one hydraulic transformer per actuator. Since cylindrical actuators use only half the applied pressure, these actuators consequently are used with only half the possible force or they must be made more stable and heavier in order to compensate for the doubled pressure.

Controllers known in the field of the art for hydraulic transformers generate simple adjustments of the control aperture of the hydraulic transformers. However, such a controller is also subject to uncertainties for the operation of the hydraulic cylinder and cannot be used for all controlled movement phases. Thus, for example a stationary state of the actuator can be achieved only in a way that is subject to time delays and oscillation. It is also possible that during extension against an external load the hydraulic cylinder will accelerate up to the maximum available pump quantity, as only then would the pressure in the pressure line collapse to the load pressure. This could result in relatively uncontrollable movements of the components connected to the hydraulic cylinder.

Furthermore, DE 198 42 534 A1 discloses a method for operating a hydrostatic drive system in which a hydraulic cylinder is controlled by means of a hydraulic transformer which is connected by its primary-end pressure connection to the pressure system and pressure medium can be fed via its secondary-end pressure connection to that pressure space of the hydraulic cylinder which is remote from the piston rod, or can be conducted away from the pressure space which is remote from the piston rod.

DE 100 06 977 A1 discloses a regulating device of a hydraulic transformer that regulates the pressure and the quantity of a pressure medium, which is fed to a hydraulic actuator to which a load is applied. The manipulated variables of a pressure regulator and of a flow rate regulator are fed to a limiting circuit in such a way that it limits the manipulated variable of the one regulator to the value of the manipulated variable of the respective other regulator if the actual value fed to the other regulator is equal to its setpoint value, and that it passes on the manipulated variable of the one regulator without limitation if the actual value fed to the other regulator is lower than the corresponding setpoint value. The output variable of the limiting circuit is fed to a rotational speed regulator as a predetermined rotational speed.

### SUMMARY OF THE INVENTION

It is an object of the present invention to make the movement sequences of the actuator automatically controlled and thus, for example, bringing about a stationary state and/or a speed with a constant setpoint value of the actuator. The integration of hydraulic transformers into a hydraulic circuit is intended to permit the otherwise unused potential and kinetic energy of activation elements of the hydraulic unit to be recovered as additionally available pressure during subsequent usage. Thus, the hydraulic transformers are supplied with the corresponding actuation signals by the controller in accordance with the respective requests to the hydraulic activation unit. The actuation signals bring about adjustment of the hydraulic transformers, which bring about changes in the strength and direction of the volume flow. The volume flows themselves act on the hydraulic cylinder, or else alternatively on a hydraulic motor which then brings about the movement of the actuator.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a schematic of a hydraulic circuit, which includes an hydraulic cylinder and an activation unit, in accordance with one embodiment of the present invention.

FIG. 2 is a schematic of a hydraulic circuit, which includes an hydraulic motor and an activation unit, in accordance with one embodiment of the present invention.

### DETAILED DESCRIPTION OF THE PRESENTLY PREFERRED EMBODIMENTS

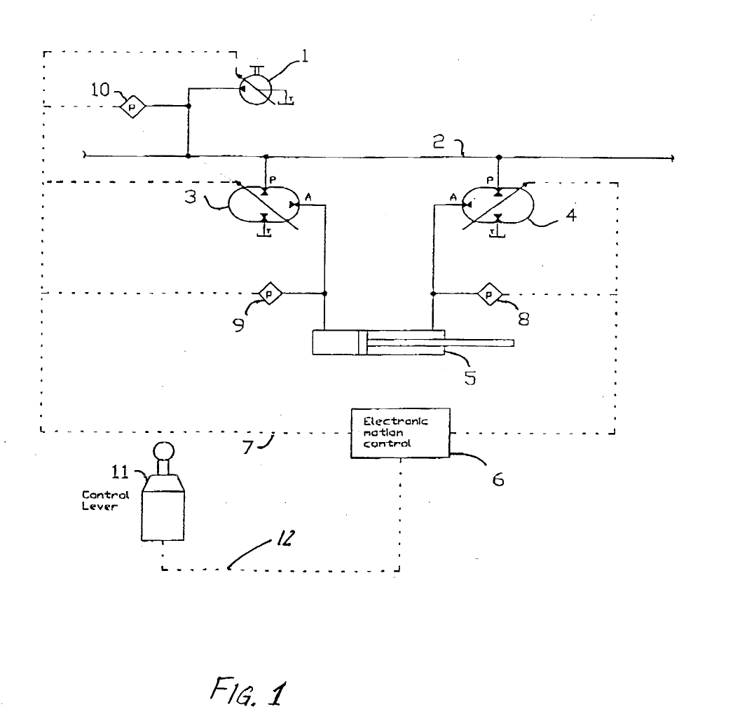

In FIG. 1, pump 1 generates a volume flow from a reserve tank at a pressure in a common pressure line 2. Hydraulic transformers 3, 4 are connected to pressure links.

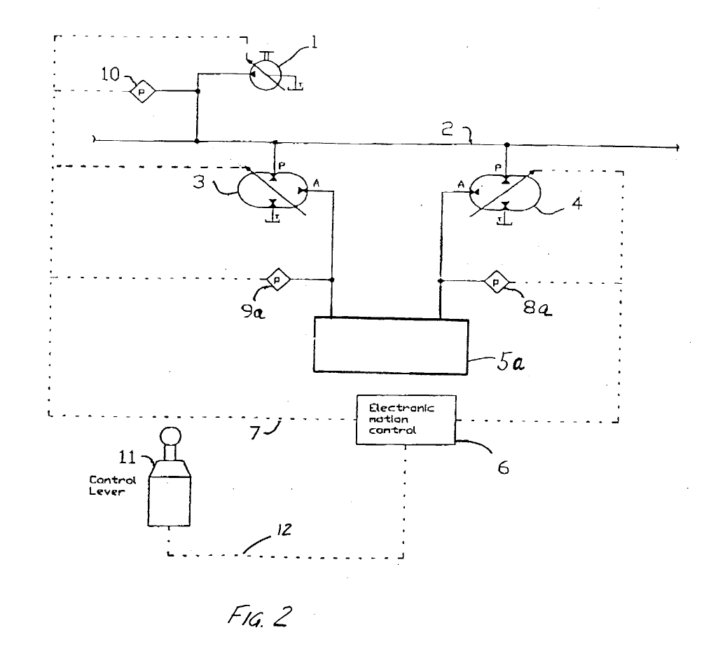

Pressure measuring devices 8, 9, 10 are connected to the pressure lines between hydraulic transformers 3, 4 and a hydraulic power unit for consuming hydraulic pressure as generating a force. In an embodiment shown in FIG. 1, the hydraulic power unit is a hydraulic cylinder 5. In an embodiment shown in FIG. 2, the hydraulic power unit is a hydraulic motor 5a.

With reference to FIG. 1, the controller 6, referred to in the drawing as “electronic motion control” is connected via the line 7 to the pump 1, the hydraulic transformers 3, 4, the pressure measuring devices 8, 9, 10. Controller 6 is also connected to control lever 11 and to other measuring devices (not shown).

Flow control, i.e. direction and rate, is interpreted as an actuation signal by the control electronics 6 by means of the pressures measured at 8, 9 at the cylinder 5 of the characteristic diagram of the hydraulic transformers 3, 4 which are used. The actuation signals and the direction signals 12 represent selection by the operator on control lever 11. The direction signals 12 then are passed to hydraulic transformers 3, 4. By reference to the measured pressures at 8, 9, 10, the control electronics 6 also decide how the hydraulic transformers 3, 4 are to be actuated at the start of the movement.

Without precise knowledge of the characteristic diagram of the hydraulic transformers 3, 4 that are used, the aforesaid controller cannot be reliably used. Only by using the characteristic diagram of the hydraulic transformers 3, 4 as fixed variables in the controller 6 is it possible for the latter to bring about a stationary state of the actuator movement by opposed control.

When the pressures measured at 8, 9, and 10, the characteristic diagrams of the hydraulic transformers 3, 4, and the transmission ratio of the cylinder 5 are present in signal form in the control electronics 6, control electronics 6 adjusts the hydraulic transformers 3 and 4 until the ratio of pressures at 8 and 9 corresponds to the transmission ratio.

Thus, the piston drums of the hydraulic transformers 3, 4 are in equilibrium and no pressure fluid flows. Analogous action occurs in rotary actuators.

If a cylinder 5 is to be extended counter to an external force, the cylinders' direction of movement is first predetermined by a direction signal 12 as specified by the operator. The direction of the pressure force present is detected by means of the pressures measured at 8, 9. The hydraulic transformer 4 is then adjusted by the control electronics 6 in such a way that it clears the outflow from the rod side of the cylinder 5 to the tank in an unthrottled way. The hydraulic transformer 3 is adjusted by the control electronics 6 in such a way that a connection is brought about from the pressure line 2 to the bottom side of the hydraulic cylinder 5.

The tank connection of the hydraulic transformer 3 remains closed at first. Given correct system configuration, the load pressure on the bottom side of the hydraulic cylinder 5 is lower than the pressure in the pressure line 2. Consequently, pressure fluid flows from the pressure line 2 to the bottom side of the hydraulic cylinder 5. As there is no appreciable opposing pressure on the rod side, the hydraulic cylinder 5 accelerates in the desired direction counter to the external force.

The retraction of a cylinder counter to a pulling load proceeds inversely. If the hydraulic cylinder 5 is to be retracted in a controlled fashion under a compressive external load, for example from the weight of the operating equipment, a predetermined direction signal 12 will first define the direction of movement. The present direction of force is detected using the pressures measured at 8, 9. Consequently, control electronics 6 adjusts hydraulic transformer 4 such that transformer 4 clears the inflow from the tank to the rod side of the cylinder 5 in an unthrottled way while its connection to the pressure line 2 remains closed. The cylinder then continues to draw pressure fluid from the tank in accordance with its retraction speed. Similarly, the hydraulic transformer 3 is adjusted by the control electronics 6 in such a way that a connection is set up from the bottom side of the hydraulic cylinder 5 to the tank. The connection of the hydraulic cylinder 3 to the pressure line 2 remains closed at first. As the load pressure on the bottom side of the hydraulic cylinder 5 is greater than the tank pressure, pressure fluid flows from the bottom side of the hydraulic cylinder 5 to the tank. The hydraulic cylinder 5 accelerates in the desired direction under the external load and starts to retract.

The use of the characteristic diagram of the hydraulic transformers 3, 4 also enables the predetermined speed of the actuator to be achieved and maintained. Therein, the actual speed of the hydraulic cylinder 5 is determined by measurement of the displacement or the volume flow in accordance with the absolute value and direction.

If the predetermined speed of the hydraulic cylinder 5 is reached, then the control electronics 6 adjust the hydraulic transformer 3 using its characteristic diagram. Thus, the inflow from the pressure line 2 is reduced while the tank connection of the hydraulic cylinder 3 is increasingly opened so that an equivalent amount of pressure fluid is drawn out of the tank line. Thus, the overall inflow from the pressure line 2 and tank remains constant for the speed. The pressure sets itself, in accordance with the ratio of the inflowing volume, and flows from the pressure line 2 and tank to the value of the load pressure on the bottom side of the hydraulic cylinder 5. The hydraulic cylinder 5 then extends at a constant present speed.

Without further adjustment, the hydraulic cylinder 5 may during the extension to counter an external load accelerate to reach the maximum available pumping capacity because only then would there be a load pressure loss in the pressure line. Thus, not only the direction but also the speed is predetermined by the size of the direction signal 12 as determined by the operator.

The actual speed of hydraulic cylinder 5 may for example be determined by the absolute value and direction by measuring displacement or volume flow.

Therein, once the extension speed of the hydraulic cylinder 5 is reached, the control electronics 6 adjust the hydraulic transformer 3. Thus, the inflow from the pressure line 2 is reduced and its tank connection is increasingly opened so that an equivalent amount of pressure is drawn out of the tank line. Thus, the overall inflow from the pressure line 2 and tank remains constant for the preset speed. The pressure sets itself in accordance with the ratio of the inflowing volume flows from the pressure line 2 and tank to the value of the load pressure on the bottom side of the hydraulic cylinder 5. The hydraulic cylinder 5 then extends at a constant preset speed.

If, for example, the load pressure rises while the predetermined speed remains the same, the hydraulic cylinder 5 decelerates somewhat. As a result of this deviation, the control electronics 6 adjust the hydraulic transformer 3 between the tank and pressure line 2 to compensate in the direction of the pressure line. Thus, the pressure flowing into the bottom side of the hydraulic cylinder 5 increases to the value of the new load pressure and the speed is corrected again to the predetermined value.

If, for example, the load pressure drops while the preset speed remains the same, the hydraulic cylinder 5 accelerates somewhat. As a result of this deviation, the control electronics 6 adjust the hydraulic transformer 3 between the tank and pressure line 2 to compensate somewhat in the direction of the tank. Thus, pressure flowing into the bottom side of the hydraulic cylinder 5 drops to the value of the new load pressure and the speed is corrected again to the predetermined value. Thus, it is possible to operate at any speed without throttle losses.

If the direction of force at the hydraulic cylinder 5 is reversed to a pulling load, the control electronics 6 detect this from the pressure measured at 8, 9. The hydraulic transformer 3 is then adjusted by the control electronics 6 such that it clears the inflow from the tank to the bottom side of the cylinder 5 in an unthrottled way its connection to the pressure line remains closed. The cylinder 5 then continues to draw pressure fluid from the tank in accordance with its extension speed. The hydraulic transformer 4 is adjusted by the control electronics 6 such that it connects the rod side of the hydraulic cylinder 5 to the tank and pressure line 2 such that precisely the load pressure is set at the rod side while the extension speed under drawing load remains constantly equal to the predetermined value. The volume flow, which flows away from the rod side, divides in accordance with the pressure relationships between the tank and pressure line 2.

Analogously, the hydraulic cylinder 5 retracts counter to a pulling load with or without a change of direction of the force.

It is also necessary to consider the opposite case where the hydraulic cylinder 5 is to be retracted under a compressive external load. Without further adjustment, the hydraulic cylinder 5 could accelerate until the pressure losses in the return flow to the tank were equal to the load pressure. This speed is too high when the load pressures are relatively high, cannot be controlled and signifies excessively high flow speeds in the components. Thus, the speed is also predetermined by the magnitude of the direction signal 12 as determined by the operator. The actual speed of the cylinder is measured in terms of absolute value and direction by, for example, measuring the displacement or volume flow. If the predetermined retraction speed of the hydraulic cylinder 5 is reached, the control electronics 6 adjust the hydraulic transformer 3. Thus, the outflow into the tank is reduced and its connection to the pressure line 2 is increasingly opened such that just as much pressure fluid is forced back into the pressure line 2 so that the overall outflow from the bottom side of the hydraulic cylinder 5 into the pressure line 2 and tank remains constant for the present speed. The pressure at the actuator connection of the hydraulic transformer 3 mixes in accordance with the ratio of the outflowing volume flows with respect to the pressure line 2 and tank to the value of the load pressure on the bottom side of the hydraulic cylinder 5. The hydraulic cylinder 5 then retracts at a constant predetermined speed.

If, for example, the load pressure rises while the predetermined the preset speed remains the same, the hydraulic cylinder 5 accelerates somewhat. As a result of this predetermined deviation, the control electronics 6 adjust the hydraulic transformer 3 between the tank and pressure line 2 to compensate in the direction of the pressure line. Thus, the pressure at the cylinder connection of the hydraulic transformer 3 increases to the value of the new load pressure and the retraction speed is corrected again to the predetermined value.

If, for example, the load pressure drops while the preset speed remains the same, the hydraulic cylinder 5 decelerates somewhat. As a result of this deviation, the control electronics 6 adjust the hydraulic transformer 3 between the tank and pressure line 2 to compensate in the direction of the tank. Thus, the pressure at the cylinder connection of the hydraulic transformer 3 decreases to the value of the new load pressure, and the speed is corrected again to the predetermined value.

Diversion of the volume flow from the tank via the hydraulic transformer 4 into the rod side of the hydraulic cylinder 5 at high speeds is reliably detected here via the pressure measurement at 9 and passed on to the control electronics 6. There the present value of the speed is adjusted downward or the hydraulic transformer 4 is adjusted such that it increasingly adds pressure fluid from the pressure line 2 until a sufficient absolute pressure at the rod side of the cylinder 5 is reached again.

With reference to FIG. 2, all the methods described for hydraulic cylinders are analogously also possible with hydraulic motors. The speed measurement can be carried out here, for example, by measuring the rotational speed or volume flow using measuring apparatus at 8a and 9a.

Therefore, to detect the overall direction of movement and speed of the cylinder, it is sufficient to measure the volume flow or displacement or rotational speed of each actuator. The regulating circuit is a further embodiment of improving the control behavior. Thus, even when the external forces on the actuator change, the required movement speed is maintained without throttle losses. Safety throttling of the pressure fluid in order to avoid excessively high-uncontrolled operational speeds or excessively high flow speeds in the connected components becomes superfluous as artificial limitations can be set on the movement by the control electronics.

Thus, it is possible to operate at any desired speed counter to or in the direction of the external loads without throttle losses. The overall efficiency of construction machinery with hydrostatic drives can be considerably increased in this way, probably even many times, which brings about a corresponding reduction in the consumption of energy with desirable economic and ecological benefits. Auxiliary equipment, such as cooling radiators, can also be designed smaller.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of controlling an hydraulic activation unit,
the hydraulic activation unit including
a hydraulic power unit (5, 5a) for producing a force;
a first hydraulic transformer (3) operably connected to a first side of the actuator (5) for supplying a pressure;
a second hydraulic transformer (4) operably connected to a second side of the actuator (5) for supplying a pressure;
a control unit (6) for assessing the first and second hydraulic transformer and operably activating the hydraulic actuator (5);
the method comprising the steps of:
(a) using a characteristic diagram of the first hydraulic transformer (3) as an input variable in the control unit (6);
(b) using a characteristic diagram of the second hydraulic transformer (4) as an input variable in the control unit (6); and
(c) activating the hydraulic actuator (5) responsive to the input variables.

2. The method of claim 1, wherein the first hydraulic transformer (3) is connected to a first side of the hydraulic actuator (5) and the second hydraulic transformer (4) is connected to a second side of the hydraulic actuator (5).

3. The method of claim 1, wherein the hydraulic power unit (5) is an hydraulic cylinder.

4. The method of claim 1, wherein the hydraulic power unit (5) is an hydraulic motor.

5. The method of claim 1, wherein the control unit (6) is an electronic control unit.

6. The method of claim 1, wherein the control unit (6) is a mechanical control unit.

7. The method of claim 1, wherein the control unit (6) is a hydraulic control unit.
